(19) United States
(12) Patent Application Publication
(10) Pub. No.: US 2002/0129955 A1
(43) Pub. Date: Sep. 19, 2002

(54) Modular box building one or more electrical devices into a wiring conduit shallower than the devices and a housing formed by an assembly of at least two such boxes

(76) Inventors: Regis Coutant, Vauciennes (FR); Frederic Xerri, Limoges (FR)

Correspondence Address: YOUNG & THOMPSON, 745 SOUTH 23RD STREET 2ND FLOOR, ARLINGTON, VA, 22202

(21) Appl. No.: 09/951,634

(22) Filed: Sep. 14, 2001

(30) Foreign Application Priority Data
Sep. 15, 2000 (FR) 0011799

(51) Int. Cl. H02G 3/08

(52) U.S. Cl. 174/50

(57) ABSTRACT

A box for building an electrical device into a wiring conduit whose depth is less than that of the device includes a lateral envelope delimiting an interior volume to receive the device, closed at the rear by a back and open at the front and provided with means for fixing it into the conduit so that, passing through a hole formed in the back of the conduit, the box and the device that it contains project to the rear of the conduit. The box receives the electrical device within its interior volume and has a line of weakness to enable a lateral portion to be detached along a lateral cut edge delimiting a lateral communication opening by which two identical boxes truncated in this way can be joined together to form a box with a larger interior volume to receive a plurality of devices or a larger device.

### BACKGROUND OF THE INVENTION

1. Field of the Invention

The present invention relates generally to fixing a device of any kind, such as a socket outlet or a telecommunication jack, into a conduit of any kind, such as a baseboard, coving, column or other form of conduit, used for electrical power and/or telecommunication installations in domestic or business premises,

2. Description of the Prior Art

In some installations, in the case of both new construction and renovation, a conduit fixed to the wall is often used for electrical or optical wiring. The conduit therefore runs horizontally along the walls, at the bottom in the manner of a baseboard, at the top in the manner of coving, or vertically against a wall, in a corner or on a column. The conduit provides a functional and protected internal wiring path enabling easy and reliable connection to diverse electrical or telecommunication devices.

The electrical devices are generally housed individually or in groups in a support frame or housing which is usually fixed directly to the wall, being recessed into the wall to a greater or lesser degree, and adjoins the conduit, or even overlaps it locally, in the transverse direction.

This has the advantage of fast installation and facilitates subsequent work. However, it has the disadvantage of a relatively large footprint on the wall (or the column), which is somewhat unesthetic and difficult to reconcile with localized problems of congestion. Moreover, “made to measure” recessing of the housing and the device(s) that it contains into the receiving wall is not always desirable or convenient.

In other installations, the conduit, which in this case is usually referred to as trunking, is deep enough to receive not only the electrical conductors but also the entire depth of the device(s) to be fixed. In this type of installation, the devices are either attached directly to the trunking or accommodated in a housing or on a support frame which is in turn attached to the trunking. An apertured plate (shield) is generally locally substituted for the cover section of the trunking to provide access via an opening of appropriate dimensions to the active front face of the device(s), which is then flush with the shield attached in this way. The housing containing the device(s) is thus entirely accommodated within the trunking, without projecting from it at the front or at the rear, the trunking being deep enough to contain the entire depth of the housing and the device(s) that it contains.

This type of installation, which has the advantage of reducing the width of the footprint on the wall, has the major disadvantage of requiring the trunking to be relatively deep throughout its length, which is highly unesthetic and usually represents a heavy penalty on the general ergonomics of the interior space delimited by the wall in question. Clearly, because of its depth, the trunking projects a relatively large distance from the wall, impeding the installation of furniture, and even the circulation of persons, trolleys or other vehicles.

In further installations, as shown in the document FR 2 729 255, for example, each electrical device is individually received in a box including a lateral envelope delimiting an interior volume receiving the device, closed at the rear by a back and open at the front, and provided on the one hand with means for fixing it into the conduit so that, passing through an opening formed in the back of the conduit, the box projects, with the device that it contains, to the rear of said conduit, and on the other hand with means for receiving the electrical device within its interior volume so that, after fixing the box into the conduit, the front face of the device is approximately flush with the front face of the conduit. Over the surplus part of its depth, which projects to the rear of the back of the conduit, the box is received in a recess in the wall specifically formed in corresponding relationship to it.

The box is therefore partly in the conduit and partly in the underlying wall against which the conduit is fixed. This configuration has the advantage of increasing [sic] as much as possible the footprint in the widthwise direction and the projection in the depthwise direction on the wall, which are limited to those of the conduit. The conduit can therefore have a small depth, determined simply to house and protect cables.

However, using this kind of individual built-in box has a major disadvantage: each box is dedicated to a single device whose dimensions are limited by those of the interior volume of the box. Consequently, if more than one device is to be installed, it is necessary to align a corresponding number of boxes in sequence, leaving an unused interstitial space between each box and the next. Clearly this considerably increases the overall size of the set of boxes and devices along the conduit. Moreover, to install a device with a large dimension in the longitudinal direction of the conduit, such as a twin device (for example a twin switch, a twin socket outlet, or a socket outlet and switch combination), it is necessary to use a special box with appropriate dimensions. Consequently, to be able to cater for all feasible configurations, the installer must have several types of box, which on the one hand represents a penalty in terms of his personal organization and on the other hand obliges manufacturers and distributors to produce and stock multiple products, to the detriment of costs.

The object of the invention is to remedy this drawback as much as possible by proposing a box of the aforementioned type having certain modular design features.

### SUMMARY OF THE INVENTION

To this end, the invention proposes a box for building at least one electrical device into a wiring conduit whose depth is less than the depth of the device, the box including a lateral envelope delimiting an interior volume to receive the device, closed at the rear by a back and open at the front and provided with means for fixing it into the conduit so that, passing through a hole formed in the back of the conduit, the box and the device that it contains project to the rear of the conduit, and with means for receiving the electrical device within its interior volume, which box has a line of weakness adapted to enable a lateral portion to be detached along a lateral cut edge delimiting a lateral communication opening by which two identical boxes truncated in this way can be joined together to form a box with a larger interior volume adapted to receive a plurality of devices or a larger device.

In this way, from two identical modular boxes, a double box is obtained able to accommodate two juxtaposed devices or a single large device. It is therefore possible, by means of a single type of modular box, supplied under a single standard product code, to produce a modular system box that can be adapted to suit the number and size of device(s) to be installed.

To enable three or more boxes to be associated, each box advantageously has two lines of weakness adapted to enable two lateral portions to be detached to join together three boxes.

The line of weakness is preferably such that, after truncation, two joined-together adjacent boxes are contiguous at their respective lateral cut edges. For example, the lateral envelope can have a globally cylindrical shape and the line of weakness can extend in a plane that is parallel to the axis of the cylindrical envelope but does not contain the axis. In this case, if the box has two lines of weakness for associating three or more modular boxes, the two lines of weakness are symmetrical with respect to and on respective opposite sides of the axis of the cylindrical envelope.

In one advantageous embodiment the means for fixing the box to the conduit include at least two lateral skids external to the envelope and adapted to be engaged with two associated slides formed longitudinally on the bottom of the conduit. This method of attaching the box to the conduit is not only simple but also convenient for the installer or a subsequent worker. In fact it is sufficient to engage the skids with the associated slides of the base section of the trunking, for example with a simple clipping action, and then to adjust the longitudinal position of the box on the conduit by causing the skids to slide in the slide.

To facilitate further use of the system and to reinforce the immobilization of the box on the bottom of the conduit, at least one of the lateral fixing skids can be mobile laterally between a configuration in which it is immobilized by friction on the corresponding slide of the conduit, a configuration in which it can slide freely on the slide, and a configuration in which it is completely released from the slide.

In this case, the mobile skid is advantageously acted on by a locking member mobile between a locking position holding the mobile skid in its configuration immobilized on the slide and an unlocking position leaving the mobile skid free to revert to its configuration of freely sliding on the slide or of complete release from the slide.

For example, the locking member of the mobile skid includes a cam member pivotally mounted on the envelope and adapted to receive an actuator of any kind for pivoting it between two angular positions constituting the locking and unlocking positions. In particular, the two angular positions of the cam member can be separated by one quarter-turn. This is the case, for example, if the cam member comprises a journal received to pivot freely in a well or bearing formed on an external boss of the envelope, a head disposed at one of the two ends of the journal and on which is formed an imprint adapted to cooperate with a screwdriver or like tool, and a shoe disposed at the other end of the journal and having the overall shape of a parallelepiped elongate transversely to the pivot axis of the journal.

To make locking more reliable, the shoe of the cam member can have a locating projection adapted to be received in an imprint formed in a corresponding part of the envelope to immobilize the cam member temporarily in a locking position.

To simplify manufacture and reduce costs, the cam member, its journal, its head and its shoe can be molded in one piece from a plastics material.

Similarly, the lateral fixing skids are molded in one piece from a plastics material with the rest of the envelope. In this case, the mobility of the mobile shoe is the result of the resilience of the shoe, with a relaxed configuration corresponding to the configuration in which it is interengaged with and slides freely on the corresponding slide of the conduit.

Again in an advantageous embodiment of the invention, the means for fixing the box to the conduit include rigid bearing lugs projecting radially outward from the envelope and adapted to bear on the bottom of the conduit. The means for fixing the box to the conduit can further include at least two locking fingers projecting outward from the envelope in substantially the same section as the rigid bearing lugs and adapted to interengage with the corresponding slide of the bottom of the conduit after radial outward deformation of the envelope.

To facilitate installation, the invention also provides a box formed by assembling a succession of at least two boxes as defined above, joined together, after detaching their lateral portions, at their open lateral sides, and including means for connecting two consecutive boxes together to ensure autonomous cohesion of the assembly that they form. The joined together modular boxes therefore constitute, even before they are installed in the conduit, a one-piece subassembly constituting a modular multiple (double, triple, or more) housing able to receive (possibly premounted therein) the whole of the device(s) to be installed.

The connecting means are then advantageously at least partly formed on the lateral envelope along the cut edge. For example, the connecting means can include on the one hand slides formed on the inside of the lateral envelope of each box, along the line of weakness or, after detaching the lateral part, along the cut edge, and on the other hand a key in the shape of an angle-iron whose branches are received in adjacent sides of two consecutive boxes. In this case, to reduce the cost of fabrication, the connecting slides are molded in one piece with the remainder of the lateral envelope from plastics material.

Other features and advantages of the invention will become apparent in the light of the following description of two particular embodiments, which description is given by way of non-limiting example and with reference to the accompanying drawings.

### BRIEF DESCRIPTION OF THE DRAWINGS

FIG. 1 is a perspective view of a modular pattress in accordance with a first embodiment of the invention.

FIG. 2 is a perspective view of a double box formed by joining together two boxes identical to that shown in FIG. 1 after detaching their lateral portions.

FIG. 3 is a locally cut away perspective view showing the use of the two joined together boxes from FIG. 2 for building in a double electrical device in a conduit whose depth is less than that of the device concerned.

FIG. 4 is a view in axial section in the plane IV in FIG. 3, showing the box fixed to the base section of the conduit.

FIG. 5 is a perspective view of a modular box in accordance with a second embodiment of the invention.

FIG. 6 is a perspective view of a triple box formed by assembling three boxes identical to that shown in FIG. 5 after detaching their lateral portions.

### DETAILED DESCRIPTION OF THE PREFERRED EMBODIMENTS

Referring to the figures, and to FIG. 3 in particular, the overall aim is to build an electrical device 100 into a wiring conduit 110 completely so that the front face of the device and the conduit are approximately flush.

The electrical device 100 shown in FIG. 3 is a double socket outlet whose construction is known in itself, does not specifically form any part of the present invention and is therefore not described in detail. Suffice to say that the device 100 includes, in the usual way, two socket mechanisms 101. The two twinned mechanisms are fastened to a common fixing plate 102. The fixing plate, usually called a support, has at its two ends two holes 103 through which are passed fixing screws 104, as explained in more detail later. The whole of the device formed by the mechanism 101 and its fixing plate 102 has an overall depth P and is concealed by an embellisher 105 attached to the mechanism 101 by two screws 106. The embellisher has an active front face 107 on which are accessible the means providing an interface with the outside (in this example, holes 108 for inserting the pins of a corresponding plug).

The wiring conduit 110, whose construction is not described in detail either, includes a base section 111 which is made from an extruded plastics material, a drawn metal such as aluminum, or rolled steel, for example. The base section 111 has a flat bottom 112 and two longitudinal flanges 113 formed by right-angled lateral rims of the bottom 112. The two flanges 113 have a height p that substantially corresponds to the overall depth of the conduit. The overall depth p of the conduit 110 is substantially less than the depth P of the device 100.

On each side of its median plane, the bottom 112 of the base section 111 has on its inside or front face two blades 118 that are inclined toward each other and form fixing rails or slides adapted to cooperate with the system in accordance with the invention. In this example the slides 118 are formed in one piece with the remainder of the base section 111, for example by extrusion. However, they could equally well be attached to it, for example by welding, riveting, etc.

A cover section 115 is attached to the base section 111 of the conduit 110 and to this end its two lateral edges are provided with two longitudinal beads 117 adapted to engage in two corresponding longitudinal grooves 114 formed at the top of the flanges 113 of the base section 111.

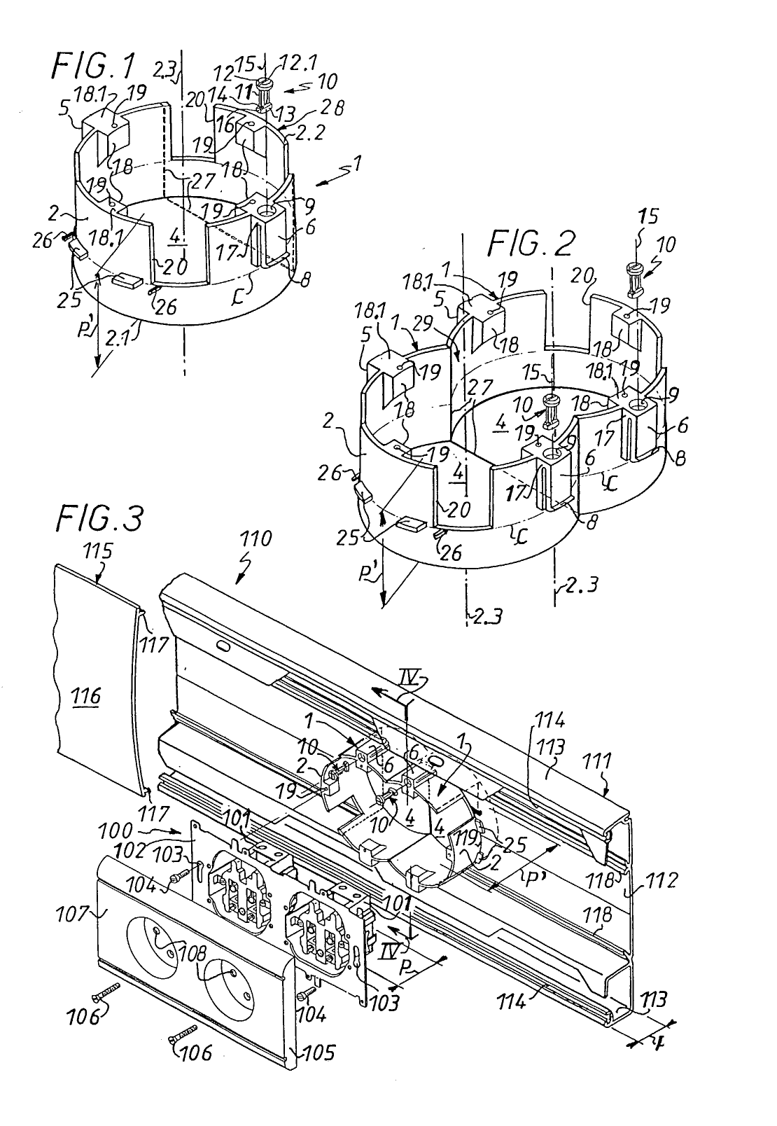

The device 100 is mounted in the conduit 110 by means of a box (see FIGS. 2 and 3) formed by joining together two modular pattresses 1 in accordance with a first embodiment of the invention.

As shown in FIG. 1, each box 1 includes a cylindrical lateral envelope 2 with an axis 2.3 whose rear edge 2.1 is closed by a solid and flat back 4 and whose front edge 2.2 is open. With its bottom 4, the envelope 2 delimits an interior volume adapted to receive a single small electrical device mechanism, such as a separate one of the two mechanisms 101 of the double device 100. The envelope 2 is perforated for entry of cables connected to the device, in this example by means of crenellations 20.

To enable the electrical device 100 to be built completely into the conduit 110, without the device 100 projecting in front of the conduit 110, given that its depth P is greater than that p of the conduit, the box 1 has a depth P′ slightly greater than that P of the device 100 and is disposed in the conduit 110 so that it passes through an opening 119 formed in corresponding relationship to it in the back 112 of the base section 111 of the conduit 110 and of itself forms in that back 112 a recess accommodating the rear part of the device 100, which projects in the depthwise direction from the conduit 110.

The opening 119 in the back 112 of the base section 111 of the conduit 110 is in corresponding relationship to the cylindrical contour of the envelope 2 and has a circular contour of substantially the same diameter.

For fixing it to the base section 111 of the conduit 110, the box 1 has fixing means formed externally on the envelope 2 along an approximately median circle C, to cooperate with, the slides 118 equipping the back 112 of the base section 111. In the example shown, two sorts of fixing means have been provided, the means that are actually used depending on the type of conduit 100 and accordingly the distance between the slides 118 equipping the back 112 of the base section 111 of the conduit.

The box 1 therefore has first fixing means compatible with a conduit 100 whose base section 111 carries widely-spaced slides. The first fixing means comprise two diametrally opposite lateral clips 5, 6 formed externally on the envelope 2. The two clips each have a heel or blade 7, 8 disposed along the aforementioned circle C to interengage with the slides 118 equipping the back 112 of the base section 111 of the conduit 110.

To be more precise, the clip 5 is relatively rigid and the clip 6 has some radial mobility, i.e. some mobility in a direction perpendicular to the longitudinal direction of the conduit 110. The clip 6 can therefore move between an immobilized by friction or clamping configuration on the corresponding slide 118 of the base section 111 of the conduit 110, a configuration in which it can slide freely on that slide, and a configuration in which it is released completely from its interengagement with the slide, enabling extraction of the box 1.

In this example box 1 is made in one piece, for example from a molded plastics material or a cast metal such as Zamak. In particular, the skids 5, 6 are in one piece with the remainder of the box 1. This being the case, the mobility of the mobile skid 6 results from the inherent resilience of the skid, with a relaxed configuration corresponding to the configuration of interengagement with and free sliding on the corresponding slide 118.

The mobile skid 6 is placed and held in its immobilized by friction or released configuration by external action forcibly flexing the mobile skid 6 against its inherent elasticity.

For example, the mobile skid 6 can be flexed toward its released configuration (if it is occasionally wished to demount the box 1) by using a screwdriver or similar tool to apply an inward retraction force on the skid to disengage it from the slide 118.

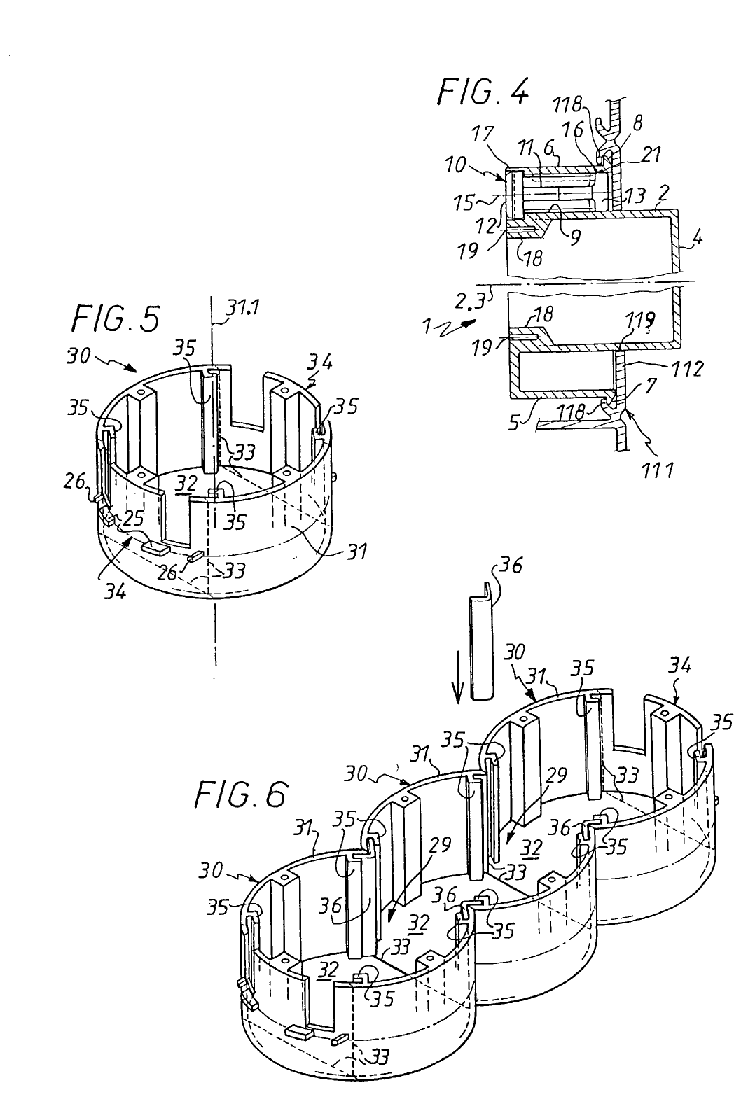

Specific means are provided for placing and holding the mobile skid 6 in its immobilized by friction configuration. To be more precise, the mobile skid 6 is acted on by a locking member 10 which is mobile between two positions, one of which, is a locking position (see FIG. 4) holding the mobile skid 6 concerned in its immobilized configuration on the slide 118 and the other of which is an unlocking position leaving the mobile skid 6 free to return to its configuration of free sliding on the slide 118 or of complete release from the slide.

In the example shown, the locking member 10 takes the form of a cam member mounted on the envelope 2 of the box 1 to pivot about an axis 15 parallel to the axis 2.3 of the cylindrical envelope 2 and adjacent the mobile skid 6 in order, to act on it radially, like a cam. The locking member 10 can therefore pivot between two angular positions constituting its positions respectively locking and unlocking the mobile skid 6. The cam member 10 comprises a journal 11 received and pivoting freely in a well or bearing 9 formed on the envelope 2, in an external boss 17 adjacent its front edge 2.2, a head 12 at one of the two ends of the journal 11 and on which is formed an imprint 12.1 adapted to accommodate the head of a screwdriver or similar tool, and a shoe 13 at the other end of the journal 11 and having a rounded bearing tip 16.

The shoe 13 has a globally parallelepipedal shape, and is elongate transversely to the pivot axis 15 of the journal 11 in the well 9 and rounded at its corners. On pivoting toward its locking position, in which it is perpendicular to the blade 8 of the mobile skid 6, i.e. perpendicular to the longitudinal direction of the conduit 110, the rounded tip 16 of the shoe 13 comes into contact with the inside face of the mobile skid 6 concerned and slides against it to push it outward, in the manner of a cam, to press it tightly against the corresponding slide 118 of the base section 111 of the conduit 110. FIG. 4 shows this final locking configuration.

Conversely, on pivoting from this locking position toward its unlocking position substantially parallel to the blade 8 of the mobile skid 6, i.e. substantially parallel to the longitudinal direction of the conduit 110, the rounded tip 16 of the shoe 13 slides against the inside face of the mobile skid 6 and moves progressively away from it until it is released from it. Note further that, as soon as the shoe 13 moves away from its locking position perpendicular to the blade 8 of the mobile skid 6 concerned, the mobile skid 6 tends to revert spontaneously to its relaxed configuration, i.e. to its configuration of sliding freely on the corresponding slide 118, and consequently, because of its inherent elasticity, to push the cam member 10 back into the unlocking position.

Accordingly, the mobile skid 6 is convenient and quick to lock in its immobilized by friction configuration by means of the cam member 10. The locking/unlocking action is of the quarter-turn type, the locking and unlocking angular positions of the cam member 10 being separated by one quarter-turn.

Furthermore, the shoe 13 of the cam member 10 has a locating projection 21 adapted to be received in an imprint (no reference number in the figures) formed on a corresponding part of the envelope 2 to immobilize the cam member 10 temporarily in the locking position. To be more precise, in the example shown, the locating projection 21 is formed on the tip 16 of the shoe 13 and the imprint receiving that protection is formed on the inside face of the mobile shoe 6 in line with the pivot axis 15 of the cam member 10.

On the same principle, an equivalent alternative solution would be to provide the locating projection on the shoe 13 of the cam member 10 on the top face 14 of the shoe (this solution is not adopted in the example shown). The imprint receiving this projection would then be formed in a lower end shoulder of the receiving well 9, whereas the head 12 of the cam member 10 would be abutted against a top end shoulder of the well 9 so that the top face 14 of the shoe 13 of the cam member 10 is pressed tightly against the end shoulder of the well 9 by virtue of slight elastic deformation of the cam member 10 as a whole.

In this example, the journal 11 of the cam member 10 has a profile of star-shaped cross section.

The cam member 10 with its journal 11, its head 12 and its shoe 13 can advantageously be molded in one piece from a plastics material.

Second means for fixing the box 1 to the base section 111 of the conduit 110 are provided on the envelope 2, along the median circle C. The second fixing means, which are adapted to cooperate with slides 118 that are closer together, are in two parts, namely a bearing part and a locking part.

The bearing part of the second fixing means consists of rigid bearing lugs 25 projecting radially outward from the envelope 2 so as to bear against the inside face (front face) of the bottom 112 of the base section 111 of the conduit 110.

The locking part of the second fixing means includes four locking fingers 26 formed on the envelope 2 and projecting outward in a common direction which, in situ, is coincident with the longitudinal direction of the conduit 110. The locking fingers 26 are adapted to pass over the slides 118 of the base section 111 of the conduit 110 by virtue of radial elastic contraction of the cylindrical envelope 2, and therefore to engage under the slides when the envelope 2 has reverted spontaneously to its relaxed position.

In its configuration shown in FIG. 1, the box 1 according to the invention is used to install a single small electrical device. The box 1 is therefore individually associated with the single device.

However, it is equally possible, in accordance with the object of the present invention, and as shown in FIGS. 2 and 3, to use two twin boxes 1 to install a double electrical device, such as the device 100 shown, or a single device with a larger longitudinal dimension.

The box 1 has some modular capacity. To be more precise, the box 1 has a line of weakness 27 extending over the cylindrical envelope 2 and the back 4 to enable a lateral portion 28 of the box 1 to be detached. The line of weakness 27 extends in a plane parallel to the axis 2.3 of the cylindrical envelope 2 but which does not contain that axis. Accordingly, when the lateral part 28 of the box 1 is detached, the line of weakness 27 exposes a lateral cut edge 27 which delimits a lateral communication opening 29 through which two adjacent and identical boxes 1 truncated in this way can be joined together, as shown in FIG. 2. The two boxes 1, juxtaposed so that their respective axes 2.3 are parallel, are joined together at their respective lateral cut edges 27. The resulting twinning of the two boxes 1 produces a double box which, offering a greater interior volume, is able to accommodate the rear parts of the two mechanisms 101 of the device 100 or the rear part of a single device mechanism with a greater longitudinal dimension.

The line of weakness 27 extends in a plane that is between the axis 2.3 and a plane tangential to the outside surface of the envelope 2, at a distance therefrom.

Accordingly, the lateral portion is formed of a cylindrical portion of the envelope 2 and a flat portion of the back 4.

The width of the opening 29 is varied by varying the distance between the plane containing the line of weakness 27 and the axis 2.3. To accommodate a single device with a great longitudinal dimension, the line of weakness 27 is at a distance from the axis 2.3 such that the width of the opening 29 is greater than the width of the device.

The modular box 1 is also provided with means for receiving the electrical device 100, to be more precise its mechanism 101, within the interior volume that it delimits. In this example the receiving means take the form of four interior bosses 18 regularly distributed over the inside face of the envelope 2 and adjacent the open front edge 2.2 of the envelope. Each of the interior bosses 18 has a front face 18.1 in the same plane as the open front edge 2.2 of the cylindrical envelope 2 and consequently perpendicular to the axis 2.3 of the envelope. A threaded hole 19 is formed parallel to the axis 2.3 in each of the interior bosses 18 and opens onto the front face 18.1 of each boss 18 to receive the fixing screw 104 associated with the fixing plate 102 of the device 100.

In the example shown in FIG. 3, in which the two boxes 1 are joined together to form a double composite box, only the hole 19 opposite the detached lateral part 28 of each of the two modular boxes 1 receives a corresponding screw 104. It is nevertheless understood that the other holes 19 can be used in other configurations, in particular if the box 1 is used on its own, to install a single device or modest size.

Regardless of the installation configuration envisaged, the receiving and fixing means of the modular box 1 are adapted so that the front face 107 of the device 100 is approximately flush with the front face 116 of the cover 115 of the conduit 110. By “approximately” is meant that the front face of the device is not necessarily exactly aligned with cover section of the conduit, and can in practice be slightly set back or project relative thereto.

To enable installation of the device 100 and to provide access to its front face 107, the cover section 115 is cut on either side of the area in which the device 100 is to be installed in the conduit 110. The opening left in this way by the localized interruption of the cover section 115 of the conduit 110 is shut off by a perforated cover or shield (not shown), which is therefore locally substituted for the missing portion of the cover sections 115. The shield has an opening whose shape and dimensions match the exterior contour of the active front face of the embellisher of the device concerned, to enable direct access to that face. Accordingly, through that opening, the active front face of the device is (approximately) flush with the front face of the shield or is set back slightly relative to that front face. In this way, the shield ensures the continuity of the cover section 115 of the conduit 110 whilst enabling access to the active front face of the device flush with the front faces of the shield and the cover 115.

Instead of this, the cover section 115 could also be locally cut to form therein, without interrupting its continuity, an opening in line with the area in which the device 100 is to be installed in the conduit 110. The opening formed in the cover section 115 in this way would then be entirely covered by the embellisher 105 of the device 100, preferably with the embellisher projecting slightly around the opening.

FIGS. 5 and 6 show a second embodiment in which the modularity of the box 30 has been enhanced. The box 30 has, in addition to its cylindrical envelope 31 with its axis 31.1 and its back 32, two lines of weakness 33 symmetrical to each other with respect to the axis 31.1 of the cylindrical envelope 31. The two lines of weakness 33 enable two lateral portions 34 of the box 30 to be detached, opening up two lateral openings at each of which the box in question can be associated with an additional box.

As shown in FIG. 6, this combines three or even more successive boxes 30, which enables the conduit 110 to accommodate any number of electrical devices and/or an electrical device with one or more mechanisms and having a large dimension in the longitudinal direction. In other words, the length of the modular housing obtained by joining together modular boxes 30 can be adapted at will to suit the number and dimensions of the device(s) to be installed.

Similarly, the circular opening 119 formed in the bottom 112 of the base section 111 of the conduit 110 is replicated a number of times corresponding to the number of boxes 30 associated in this way, with an offset between each opening and the next corresponding to the existing distance between the centers of two consecutive joined-together boxes, this distance necessarily being less than the diameter of the box, given that the box has been truncated. In this regard, note that using a single modular box offers the additional advantage of requiring only one tool to make the openings 119 in the bottom 112 of the base section 111, the tool raking a single size of circular opening with substantial the same diameter as the box. The opening obtained with the tool is simply replicated as many times as necessary, with the necessary offset (distance between centers less than the diameter of the opening 119), to obtain a larger overall opening with a shape perfectly matched to that of the contour of the combined modular pattress obtained by associating a series of modular boxes.

Also, in this second embodiment, connecting means are provided for autonomous cohesion of the pattress formed globally by the joined-together boxes 30. Clearly such connecting means enable not only the simple joining together of juxtaposed modular boxes located relative to each other by virtue of their individual fixing to the conduit 110 (as is the case in the first embodiment previously described with reference to FIGS. 1 to 4), but true assembly of pairs of modular boxes 30 to obtain a one-piece box that can be manipulated in one piece, separate from the conduit 110. It is therefore in particular possible to use the box formed by this assembly of modular boxes to pre-install and possibly pre-wire the electrical device(s) to be installed. This pre-installation can even be effected in the workshop before shipping to the site.

To be more precise, in the example shown in FIGS. 5 and 6, the means for connecting the boxes together include on the one hand a slide 35 projecting from the inside face of the lateral envelope 31 of each modular box 30, parallel to the axis 31.1, along the part of the line of weakness 33 on the envelope 31, that is to say, after detaching the lateral portion 34, along the corresponding portion of the cut edge 33. The connecting means further include a key 36 with the general shape of an angle-iron whose branches are adapted to be received in the adjacent slides 35 of two consecutive boxes, contiguously at their respective cut edges.

The connecting slides 35 are preferably molded in one piece with the remainder of the envelope 31 from a plastics material, for example.

Of course, the means of connecting two consecutive boxes together are not limited to those described above with reference to FIGS. 5 and 6. For example, consideration could be given to making the connecting means in the form of complementary slides, one male and the other female, along the part of the cut edge 33 that is part of the envelope 31, on ether side of the lateral communicating opening, and adapted so that the adjacent slides of two consecutive boxes brought together edge to edge nest one within the other in an assembly movement in a direction parallel to the axis 31.1 of the cylindrical envelope 31, no external key or clip then being needed.

Regardless of the solution adopted, it is preferable to provide means for locking the connecting means. For example, locking could be achieved by tight nesting of the key in the slide (or of the slides in each other in the case of a connection through complementary slides) or by clipping means adapted to immobilize the key temporarily in the slides (or the complementary slides in each other) at the end of a stroke.

There is claimed:

1. A box for building an electrical device into a wiring conduit whose depth is less than that of said device, said box including a lateral envelope delimiting an interior volume to receive said device, closed at the rear by a back and open at the front and provided with means for fixing it into said conduit so that, passing through a hole formed in the back of said conduit, said box and the device it contains project to the rear of said conduit, and with means for receiving said electrical device within its interior volume, which box has a line of weakness adapted to enable a lateral portion to be detached along a lateral cut edge delimiting a lateral communication opening by which two identical boxes truncated in this way can be joined together to form a box with a larger interior volume adapted to receive a plurality of devices or a larger device.

2. The box claimed in claim 1 having two lines of weakness adapted to enable two lateral portions to be detached to join together three boxes.

3. The box claimed in claim 1 wherein said line of weakness is such that, after truncation, two joined-together adjacent boxes are contiguous at their respective lateral cut edges.

4. The box claimed in claim 3 wherein said lateral envelope has a globally cylindrical shape and said line of weakness extends in a plane parallel to the axis of said cylindrical envelope but that does not contain said axis.

5. The box claimed in claim 2 wherein said two lines of weakness are symmetrical with respect to said axis of said cylindrical envelope.

6. The box claimed in claim 1 wherein said means for fixing it to said conduit include at least two lateral skids provided externally on said envelope to interengage with two associated slides formed longitudinally on said back of said conduit.

7. The box claimed in claim 6 wherein at least one of said lateral fixing skids is mobile laterally between a configuration in which it is immobilized by friction on the corresponding slide of said conduit, a configuration in which it slides freely on said slide, and a configuration in which it is completely released from its interengagement with said slide.

8. The box claimed in claim 7 wherein said mobile skid is acted on by a locking member mobile between two positions, namely a locking position holding said mobile skid in its immobilized configuration on said slide and an unlocking position leaving said mobile skid free to revert to its configuration of sliding freely on said slide or of complete release of its interengagement with said slide.

9. The box claimed in claim 8 wherein said locking member of said mobile skid includes a cam member mounted to pivot on said envelope and adapted to be actuated by pivoting it between two angular positions constituting its aforementioned locking and unlocking positions.

10. The box claimed in claim 9 wherein said two angular positions of said cam member are separated by a quarter-turn.

11. The box claimed in claim 10 wherein said cam member includes a journal received and pivoting freely in a well or bearing formed on an exterior boss of said envelope, a head disposed at one end of said journal and on which is formed an actuation imprint adapted to cooperate with a screwdriver or like tool, and a shoe disposed at the other end of the journal and having a globally parallelepipedal shape elongated transversely to said pivot axis of said journal.

12. The box claimed in claim 11 wherein said shoe of said cam member has a locating projection adapted to be received in an imprint formed in a corresponding part of said envelope to immobilize said cam member in said locking position temporarily.

13. The box claimed in claim 12 wherein said locating projection of said shoe is formed at the tip of said shoe and said imprint for receiving said projection is formed in said mobile shoe in line with said pivot axis of said cam member.

14. The box claimed in claim 12 wherein said locating projection of said shoe is formed on the top of said shoe and said imprint for receiving said projection is formed in a rear shoulder of said well receiving said journal, the head of said cam member being abutted against a front end shoulder of said well so that the top of said shoe of said cam member is pressed tightly against said rear end shoulder of said well by virtue of slight elastic deformation of said cam member as a whole.

15. The box claimed in claim 11 wherein said journal of said cam member has a profile of star-shaped cross section.

16. The box claimed in claim 12 wherein said cam member, its journal, its head and its shoe are molded in one piece from a plastics material.

17. The box claimed in claim 6 wherein said lateral fixing skids are molded in one piece with the remainder of said envelope from a plastics material.

18. The box claimed in claim 17 wherein the mobility of said mobile skid is the result of the resilience of said skid, with a relaxed configuration corresponding to said configuration in which it is interengaged with and slides freely on the corresponding slide of said conduit.

19. The box claimed in claim 1 wherein said means for fixing it to said conduit include rigid bearing lugs projecting radially outward from said envelope and adapted to bear on said back of said conduit.

20. The box claimed in claim 19 wherein said means for fixing it to said conduit include at least two locking fingers projecting externally from said envelope, on substantially the same section as said rigid bearing lugs, so as to interengage, after radial deformation of said envelope, with the corresponding slide of said back of said conduit.

21. A box formed by assembling a succession of at least two boxes as claimed in claim 1, joined together, after detaching their lateral portions, at their open lateral sides, and including means for connecting two consecutive boxes together to ensure autonomous cohesion of the assembly that they form.

22. The box claimed in claim 21 wherein said connecting means are at least partly formed on said lateral envelope along said cut edge.

23. The box claimed in claim 22 wherein said connecting means include slides formed on the inside of said lateral envelope of each box, along said line of weakness or, after detaching said lateral part, along said cut edge, and on the other hand a key in the shape of an angle-iron whose branches are received in adjacent slides of two consecutive boxes.

24. The box claimed in claim 23 wherein said connecting slides are molded in one piece with the remainder of said lateral envelope from plastics material.
